(19) United States
(12) Patent Application Publication
(10) Pub. No.: US 2011/0174839 A1
(43) Pub. Date: Jul. 21, 2011

(54) UNDER COUNTER DRINKING FOUNTAIN

(76) Inventor: Hsiao-Mei LIN, Taichung City (TW)

(21) Appl. No.: 12/982,492

(22) Filed: Dec. 30, 2010

(30) Foreign Application Priority Data
Jan. 15, 2010 (TW) 099200909

(51) Int. Cl. B67D 7/82

(52) U.S. Cl. 222/146.2

(57) ABSTRACT

An under counter drinking fountain of the present invention includes an electronic faucet. The electronic faucet includes an outlet pipe, a steam pipe, and a control device. The steam pipe is disposed with a valve. The control device can control liquid in the under counter drinking fountain to flow to the outlet pipe so as to output water for a user. The control device controls the valve to close the steam pipe as water is output from the outlet pipe. Thereby, it can not only avoid the liquid inside of the drinking fountain flowing out from the steam pipe, but also prevent the user from wasting water and scalding.

### BACKGROUND OF THE INVENTION

1. Field of the Invention

The present invention relates to a faucet of a drinking fountain, and more particularly to an electronic faucet of an under counter drinking fountain.

2. Description of the Prior Art

Please refer to FIG. 1. A conventional under counter drinking fountain often includes a hot water unit 1, a reverse osmosis unit 2, and a faucet 3. A steam pipe 4 is located between the faucet 3 and the hot water unit 1. The steam pipe 4 is mainly provided to discharge steam from the hot water unit 1.

In a structure of said under counter drinking fountain, an outlet of the steam pipe is disposed near a drinking water outlet 5, or disposed on a drain pipe. When a user uses the drinking fountain, the user is prone to be burned by hot water drops or the steam which are discharged from the steam pipe 4. Besides, the steam pipe often directly communicates with a reservoir of the hot water unit 1, so that hot water is easy to be discharged from the steam pipe as the hot water unit is outputting water. Consequently, in addition to getting burned easily, it further wastes water imperceptibly.

The present invention is, therefore, arisen to obviate or at least mitigate the above mentioned disadvantages.

### SUMMARY OF THE INVENTION

The main object of the present invention is to provide an under counter drinking fountain which can prevent a steam pipe from discharging water as the water is output from the drinking fountain.

To achieve the above and other objects, an under counter drinking fountain of the present invention includes an electronic faucet. The electronic faucet is disposed with an outlet pipe, a steam pipe, and a control device. The steam pipe is disposed with a valve. The control device is adapted for a user to control liquid inside of the under counter fountain to flow to the outlet pipe. At the same time, the control device can close the valve so as to close the steam pipe. Thereby, it prevents the liquid from flowing out through the steam pipe, so that it can avoid the user scalding or wasting water.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a schematic drawing showing a disposition of a conventional under counter drinking fountain;

FIG. 2 is a stereogram showing an electronic faucet of an under counter drinking fountain in accordance with an embodiment of the present invention;

FIG. 3 is a sectional drawing showing an under counter drinking fountain in accordance with an embodiment of the present invention;

FIG. 4 is a schematic drawing showing a structure of a reservoir inside of an under counter drinking fountain in accordance with an embodiment of the present invention;

FIG. 5 is a schematic drawing showing a heater of an under counter drinking fountain in accordance with another embodiment of the present invention;

FIG. 6 is a sectional drawing showing an under counter drinking fountain in accordance with another embodiment of the present invention.

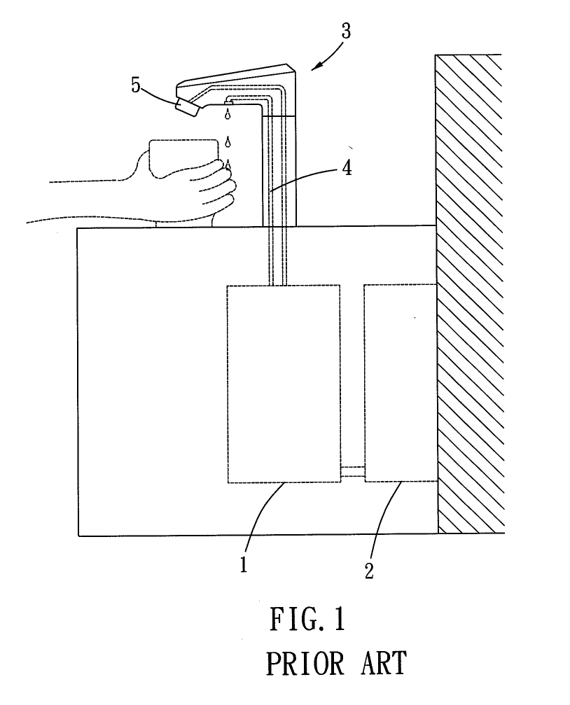

### DETAILED DESCRIPTION OF THE PREFERRED EMBODIMENTS

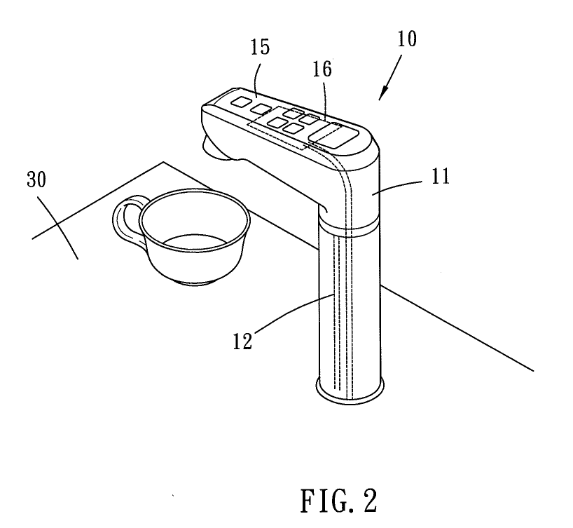

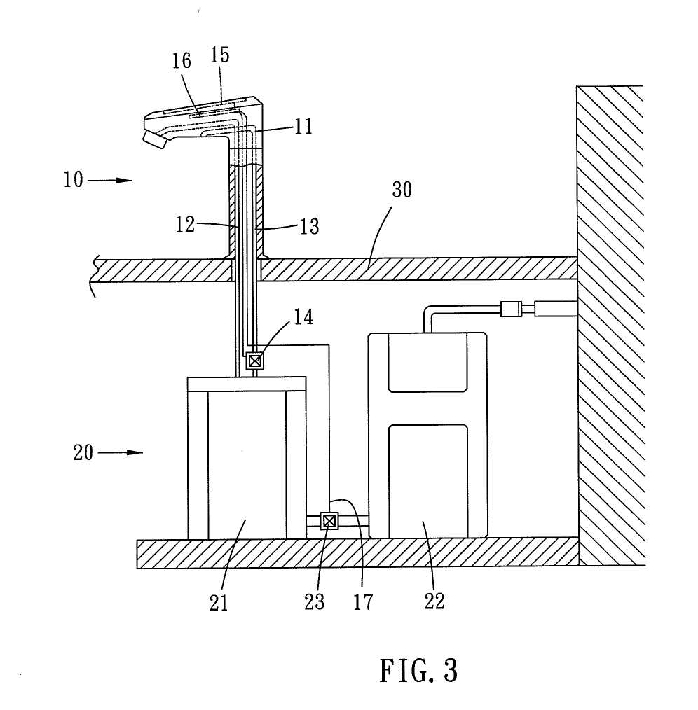

Please refer to FIG. 2 and FIG. 3. An under counter drinking fountain of the present invention includes an electronic faucet 10 and a water supply set 20. The electronic faucet 10 is adapted to be convexly disposed on a surface of a desk 30, and the water supply set 20 is hidden and disposed under the desk 30. The water supply set 20 can include one or more reservoirs 21 for storing water. The water supply set can further be disposed with a purifying device 22 such as a filter or a reverse osmosis system. The purifying device 22 which is connected to the reservoir 21 can purify external water and then store the water in the reservoir 21. The reservoir 21 can be disposed with an output device 23, such as a press motor or an electromagnetic valve, which is connected to the purifying device 22 or the reservoir 21. The output device 23 can be controlled by a user to output liquid which is stored in the reservoir 21 to the electronic faucet 10 for the user to drink.

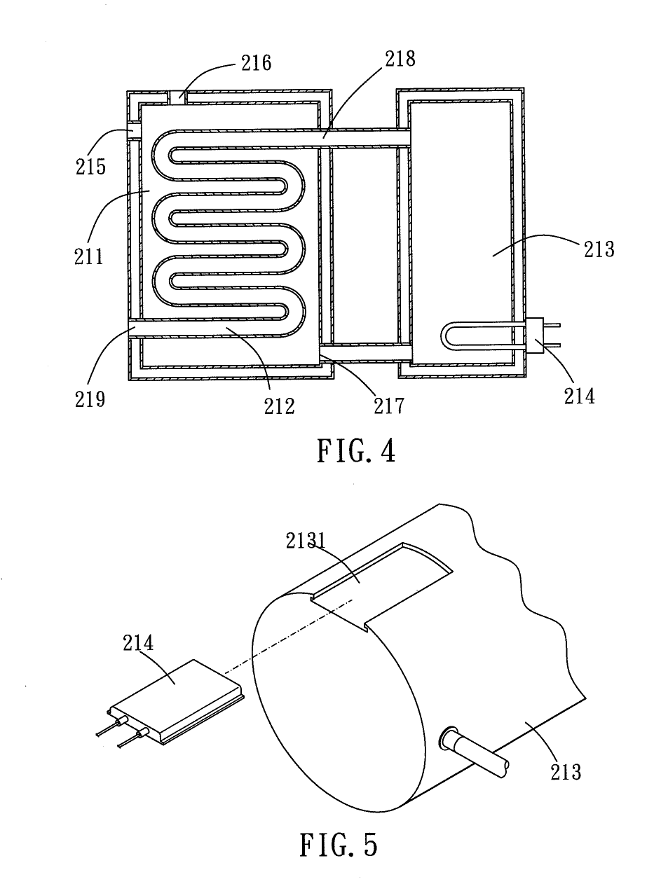

Please refer to FIG. 4. The reservoir 21 can include a hot water tank 211, an inlet pipe 212, a heating container 213, and a heater 214.

The hot water tank 211 has a hot water outlet 215, a steam outlet 216, a hot water inlet 217, a cold water outlet 218, and a cold water inlet 219. The cold water inlet is connected to the output device 23. The inlet pipe 212 connects the cold water inlet 219 to the cold water outlet 218, and the cold water outlet 218 is connected to the heating container 213. The heater 214 is disposed on the heating container 213 so as to heat water contained within the heating container 213. The heating container 213 is connected to the hot water inlet 217. Thereby, as the output device 23 is activated, the water can flow through the output device 23 to the cold water inlet 219 so that the water flows into the inlet pipe 212 and the cold water outlet 218, and then flowing into the heating container 213. After being heated by the heater 214, the water flows back to the hot water tank 211 again, and the water is then available for drinking. Wherein, before flowing into the heating container 213, cold water follows the inlet pipe 212 to flow through an interior of the hot water tank 211. In this way, the cold water will be warmed by the water inside of the hot water tank 211 before flowing into the heating container 213 so as to shorten the required time of heating.

In addition to the heater 21 of the embodiment of the present invention as shown in the FIG. 4, the heating container 213 can also be formed with a chute 2131 as shown in the FIG. 5. The heater 214 can slide into the chute 2131 and then be disposed therein. Thereby, the heater 214 can be detached and replaced by the user. If the heater 214 is broken, the heater 214 can be detached for repairing or changing into a new one. In other words, the heater is convenient to be maintained and repaired.

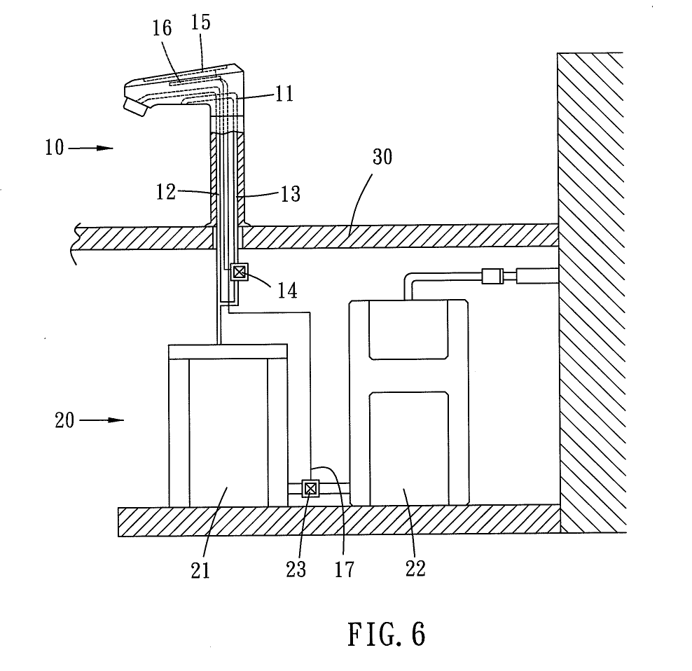

Please refer to FIG. 3. The electronic faucet 10 includes a faucet 11, a pipe set, and a control device. The faucet 11 is used for being convexly disposed on a surface of a desk 30. The pipe set which communicates with the reservoir 21 includes at least one outlet pipe 12 and a steam pipe 13. Two sides of the outlet pipe 12 and the steam pipe 13 are respectively fixed with the faucet 11 and the reservoir 21. More specifically, the outlet pipe 12 is connected to the hot water outlet 215, and the steam pipe 13 is connected to the steam outlet 216. Please refer to FIG. 6. Two sides of the steam pipe 12 can also be fixed with the outlet pipe 12 and the faucet 11. Thereby, liquid inside of the reservoir 21 can flow through the outlet pipe 12 and be output therethough. Steam inside of the reservoir 21 can be discharged from the steam pipe 13, wherein the outlet pipe 12 and one end of the steam pipe 13 which is fixed with the faucet 11 can be disposed away from each other so as to prevent the user from being burned by the steam. The steam pipe 13 is further disposed with a valve 14. The valve 14 has a power device, such as a motor or an electromagnetic valve, which can be driven to selectively close the valve 14 so as to close the steam pipe 13. Please refer to FIG. 2 and FIG. 3 again. The control device includes a control member 15 and a control circuit 16. The control member 15 can be a sensor or a press controller for the user to operate and control. The control circuit 16 is connected to the control member 15 and the valve 14, and the control circuit 16 also connects to the power device of the valve 14. The control circuit 16 further comprises an output terminal 17 which is connected to it. The output terminal 17 is connected to the output device 23 so as to make the control circuit 16 can be controlled to generate an output signal by the control member 15. As the output device 23 receives the output signal, the output device 23 outputs liquid to the pipe set, and the valve 14 is controlled to be closed at the same time.

Accordingly, the under counter drinking fountain of the present invention can heat the liquid inside of the reservoir with the heater. The steam generated in heating the liquid can be discharged from the steam pipe so as to avoid high pressure caused by accumulating too much steam inside of the reservoir. The user can manipulate the control member to make the control circuit control the output device to output water, so that a water level inside of the reservoir rises and then the liquid flows into the pipe set. Meanwhile, the control circuit controls the power device to close the valve so as to make the liquid flow out for drinking through the outlet pipe only and prevent the liquid from leaking through the steam pipe. Consequently, it can avoid wasting water or drinks and burning by the water flowing out from a position other than the outlet pipe. Therefore, the present invention can save resources and be safely used.

What is claimed is:

1. An under counter drinking fountain, comprising:
an electronic faucet, comprising a pipe set and a control device, the pipe set including at least one outlet pipe and a steam pipe, the outlet pipe being adapted for liquid flowing therethrough, the steam pipe being adapted for steam to flow therethrough, the steam pipe being disposed with a valve, the control device including a control circuit and a control member, the control circuit connecting the control member to the valve, the control circuit having an output terminal, the control circuit generating an output signal by control of the control member, the control circuit closing the vale when the output signal is generated so as to close the steam pipe;
a water supply set, comprising at least one reservoir, the reservoir being adapted to store the liquid, the pipe set being connected to the reservoir, the reservoir being disposed with an output device, the output device being connected to the output terminal, the output device outputting the liquid as receiving the output signal.

2. The under counter drinking fountain of claim 1, wherein the valve is further disposed with a power device, the power device in connected to the control circuit, the power device selectively closes the valve by control of the control circuit.

3. The under-counter drinking fountain of claim 1, wherein the reservoir comprises a hot water tank, an inlet pipe, a heating container, and a heater, the hot water tank has a hot water outlet, a steam outlet, a hot water inlet, a cold water outlet, and a cold water inlet, the cold water inlet is connected to the output device, the inlet pipe connects the cold water inlet to the cold water outlet, the cold water outlet is connected to the heating container, the heater is disposed on the heating container so as to heat water in the heating container, the heating container is connected to the hot water inlet, the hot water outlet is connected to the outlet pipe, and the steam outlet is connected to the steam pipe.

4. The under counter drinking fountain of claim 3, wherein the heating container is formed with a chute, the heater slides into the chute, and the heater is then disposed therein.
